(19) United States
(12) Patent Application Publication
(10) Pub. No.: US 2017/0293683 A1
(43) Pub. Date: Oct. 12, 2017

(54) METHOD AND SYSTEM FOR PROVIDING CONTEXTUAL INFORMATION

(71) Applicant: YANDEX EUROPE AG, Luzern (CH)

(72) Inventors: Andrey Veniaminovich SAPOZHNIKOV, Moscow (RU); Anton Igorevich CHEKANIN, Moscow (RU); Egor Sergeevich ANTONOV, Moscow (RU)

(21) Appl. No.: 15/464,392

(22) Filed: Mar. 21, 2017

(30) Foreign Application Priority Data
Apr. 7, 2016 (RU) 2016113228

(51) Int. Cl. G06F 17/30

(52) U.S. Cl. CPC G06F 17/30696; G06F 17/30684

(57) ABSTRACT

A method of providing contextual information related to a document. A textual content of a document displayed on an electronic device is analyzed to identify a plurality of objects. For each object, at least one meaning including a most probable meaning is identified. The most probable meaning is determined specifically for the document based at least in part on a context analysis thereof. A given object is determined to be significant or not. Responsive to determining that a given object is significant, a contextual search result including contextual information related to the most probable meaning of the given object is obtained. A portion of the document corresponding to the given object is caused to be modified. The contextual search result is caused to be associated with the given object in the document displayed on the electronic device. Electronic device and server for executing the method are also disclosed.

### CROSS-REFERENCE

The present application claims priority to Russian Patent Application No. 2016113228, filed Apr. 7, 2016, entitled “METHOD AND SYSTEM FOR PROVIDING CONTEXTUAL INFORMATION”, the entirety of which is incorporated herein by reference.

### FIELD

The present technology relates to methods and systems for providing contextual information.

### BACKGROUND

A browser application such as Mozilla Firefox™, Google Chrome™, Yandex™, and the like can be used to access information via various kinds of global or local communication networks (the Internet, the World Wide Web, local area networks and the like). The available information includes a variety of content types, such as photos, video, audio and the like, and relates to a wide range of topics, such as but not limited to news, weather, traffic, entertainment, finance and the like. The information is accessed using a wide range of electronic devices such as desktop computers, laptop computers, smartphones, tablets and the like. Users can access a particular resource directly, either by typing an address of the resource (typically an URL or Universal Resource Locator, such as www.webpage.com) or by clicking a link in an e-mail or in another web resource. Browser applications typically also provide a search function that allows the user to search for information on a topic of interest.

Often, when viewing a document, whether in a browser application or another application, a user may desire additional information related to some topic that is being reviewed. The user would then typically open a new web page, and in the new web page, perform a search for the topic of interest using the search function provided. When performing searches, the user typically wants to locate the most relevant results and desires to obtain those results relatively quickly. Sometimes, however, the user may not know exactly what search query will provide the information he or she wants, and may thus need to enter many trial search queries in order to obtain the desired relevant search results. Alternately, the user may have to review a large number of search results before finding a relevant search result. This process can be time consuming and thus inconvenient for the user. It is also inconvenient for the user to have to navigate to a separate window (separate from the current document being viewed by the user) to search for the additional information. In addition to the inconveniences to the user, the execution of multiple trial searches also uses up valuable resources such as communication bandwidth and battery.

### SUMMARY

[05] It is an object of the present technology to ameliorate at least some of the inconveniences present in the prior art.

Implementations of the present technology have been developed based on inventors' appreciating that there exists at least one problem or an area for improvement associated with the prior art solutions.

In accordance with a broad aspect of the present technology, there is provided a method of providing contextual information related to a document displayed on a client electronic device. The method is executed by a processor. The method includes obtaining a textual content of the document displayed on the client electronic device, and analyzing the textual content to identify a plurality of objects in the textual content. Each of the plurality of objects includes at least one word. For each one of the plurality of objects, a respective at least one meaning is identified. A respective most probable meaning is determined for each one of the plurality of objects. The most probable meaning is determined specifically for the document based at least in part on a context analysis of the document with respect to each of the at least one meaning of each one of the plurality of objects. For a given object of the plurality of objects, it is determined if the given object is significant for the document. Responsive to determining that the given object is significant, a contextual search result is obtained related to the most probable meaning of the given object, the contextual search result including contextual information for the given object associated with the most probable meaning thereof. Responsive to determining that the given object is significant, a portion of the document corresponding to the given object is caused to be modified. Responsive to determining that the given object is significant, the contextual search result is caused to be associated with the given object in the document displayed on the client electronic device.

In some implementations, determining if the given object is significant for the document includes comparing a contextual relevance of the most probable meaning of the given object to a contextual relevance threshold and responsive to the contextual relevance of the most probable meaning of the given object being greater than the contextual relevance threshold, determining that the given object is significant.

In some implementations, the determining if the given object is significant for the document includes comparing a contextual relevance of the most probable meaning of the given object to a respective contextual relevance of the respective most probable meaning of each one of the plurality of objects other than the given object, and determining that the given object is significant for the document responsive to the contextual relevance of the most probable meaning of the given object being greater than the respective contextual relevance of the most probable meaning of each one of the plurality of objects other than the given object.

In some implementations, the determining if the given object is significant for the document is based at least in part on at least one of the following: a frequency of occurrence in the document of the at least one word comprised in the first object, a popularity of the at least one word comprised in the first object, a position of the given object, and an object type of the given object.

In some implementations, the given object is a first object and the contextual search result is a first object contextual search result. The method further includes determining if a second object of the plurality of objects is significant for the document. If it is determined that the second object is significant, a second object contextual search result related to the most probable meaning of the second object is obtained. The second object contextual search result includes contextual information for the second object associated with the most probable meaning thereof. A portion of the document corresponding to the second object is caused to be modified. The second object contextual search result is caused to be associated with the second object in the document displayed on the client electronic device.

In some implementations, the determining if the first object is significant for the document includes comparing a contextual relevance of the most probable meaning of the first object to a contextual relevance threshold and determining the first object to be significant responsive to the contextual relevance of the most probable meaning of the first object being greater than the contextual relevance threshold. Determining if the second object is significant for the document includes comparing a contextual relevance of the most probable meaning of the second object to the contextual relevance threshold and determining the second object to be significant responsive to the contextual relevance of the most probable meaning of the second object being greater than the contextual relevance threshold.

In some implementations, the determining if the first object is significant for the document includes comparing a contextual relevance of the most probable meaning of the first object to a respective contextual relevance of the respective most probable meaning of each one of the plurality of objects other than the first object. The first object is determined to be significant for the document responsive to the contextual relevance of the most probable meaning of the first object being greater than the respective contextual relevance of the most probable meaning of each one of the plurality of objects other than the first object. The determining if the second object is significant for the document includes comparing the contextual relevance of the most probable meaning of the second object to the respective contextual relevance of the respective most probable meaning of each one of the plurality of objects other than the second object. The second object is determined to be significant for the document responsive to the contextual relevance of the most probable meaning of the second object being greater than the respective contextual relevance of the most probable meaning of each one of the plurality of objects except the second object and the first object.

In some implementations, obtaining the contextual search result related to the most probable meaning of the given object includes performing a contextual search using the most probable meaning of the given object as a contextual search query to obtain the contextual search result.

In some implementations, performing the contextual search includes performing the contextual search responsive to the user interacting with the given object in the document displayed on the client electronic device.

In some implementations, causing a portion of the document corresponding to the given object to be modified includes causing the at least one word corresponding to the given object to be user-selectable such that a user selection of the at least one word corresponding to the given object causes presentation of the contextual search result obtained for the most probable meaning for the given object.

In some implementations, causing the contextual search result to be associated with the given object in the document displayed on the client electronic device includes causing displaying of the contextual search result in proximity to the at least one word in the document corresponding to the given object.

In some implementations, a contextual information card is prepared based on the contextual search result. Causing displaying of the contextual search result includes causing displaying of the contextual information card.

In some implementations, the method is executed at a server including the processor, the server being communicatively coupled to the client electronic device. Obtaining the textual content of the document displayed on the client electronic device includes receiving, from the client electronic device, an indication of the document. Causing a portion of the document corresponding to the given object to be modified includes transmitting to the client electronic device an indication of the given object. Causing the contextual search result to be associated with the given object in the document displayed on the client electronic device includes transmitting to the client electronic device the contextual search result.

In some implementations, the method is executed at the client electronic device. Obtaining the contextual search result related to the most probable meaning of the given object includes sending to a search engine server the most probable meaning of the given object as a contextual search query, and receiving from the search engine server, the contextual search result including contextual information for the given object for the most probably meaning thereof.

In accordance with another broad aspect of the present technology, there is provided an electronic device for providing contextual information related to a document. The electronic device includes a processor, a user output device communicatively coupled to the processor for displaying the document, and a network communication interface communicatively coupled to the processor for communicating with a search engine server. The processor is configured to execute the above method. Obtaining the contextual search result related to the most probable meaning of the given object includes sending to the search engine server the most probable meaning of the given object as a contextual search query, and receiving from the search engine server the contextual search result including contextual information for the given object for the most probably meaning thereof.

In accordance with another broad aspect of the present technology, there is provided a server for providing contextual information related to a document displayed on a client electronic device, the server includes a processor and a network communication interface communicatively coupled to the processor for communicating with client electronic device. The processor is configured to execute the above method. Obtaining the textual content of the document displayed on the client electronic device includes receiving, from the client electronic device, an indication of the document. Causing a portion of the document corresponding to the given object to be modified includes transmitting to the client electronic device an indication of the given object. Causing the contextual search result to be associated with the given object in the document displayed on the client electronic device includes transmitting to the client electronic device the contextual search result.

In some implementations, obtaining the contextual search result related to the most probable meaning of the given object includes performing a contextual search using the most probable meaning of the given object as a contextual search query to obtain the contextual search result.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, a “web resource” is any data or collection of data that can be provided by a publisher over a network and that is associated with a web resource address. Non-limiting examples of web resources include HTML pages, documents, images, video, feed sources, as well as pluralities of files such as the foregoing. Web resources may include content, such as words, phrases, pictures, and so on, and/or embedded information such as metadata, hyperlinks and/or embedded instructions (such as JavaScript scripts).

In the context of the present specification, “client device”, “electronic device”, or “client electronic device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic illustration of a system in accordance with a non-limiting implementation of the present technology;

FIG. 2 is a schematic block diagram of an electronic device of the system of FIG. 1 in accordance with a non-limiting implementation of the present technology;

FIG. 3 is a flow chart of a method for providing contextual information in accordance with some implementations of the present technology;

FIG. 4 is a schematic illustration of a portion of a document displayed on an electronic device showing exemplary contextual information provided using the method of FIG. 3; and

FIG. 5 is a schematic illustration of two objects of a plurality of objects in the textual content of the document of FIG. 4, each object being shown along with a respective set of possible meanings in accordance with some implementations of the present technology.

### DETAILED DESCRIPTION

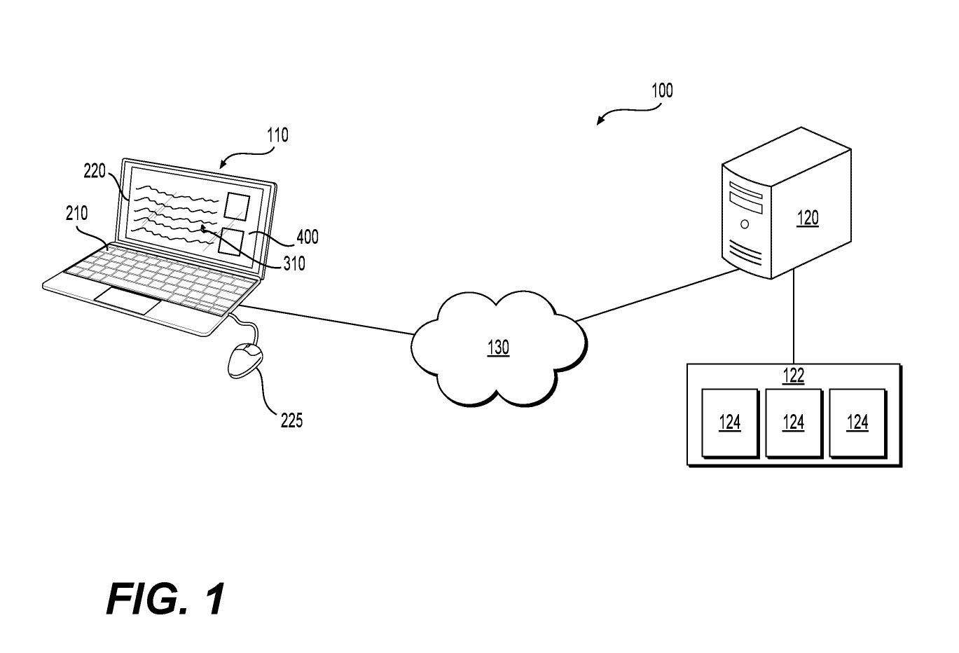

With reference to FIG. 1, there is shown a schematic diagram of a system 100 suitable for use with some implementations of the present technology. It should be understood that the system 100 is shown herein merely as an illustrative implementation of the present technology. Thus, the description of the system 100 that follows is intended to be only a description of illustrative examples of the present technology. This description is not intended to define the scope or set forth the bounds of the present technology.

In some cases, what are believed to be helpful examples of modifications to the system 100 may also be set forth below. The modifications are described merely as an aid to understanding, and again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

Generally speaking, the system 100 is configured to provide contextual information in accordance with non-limiting implementations of the present technology. The system 100 includes an electronic device 110, a server 120 and a communication network 130. The electronic device 110 communicates with the server 120 via the communication network 130. Although the present description is made with reference to the system 100 having one electronic device 110 and one server 120, it should be understood that the system 100 could include more than one electronic device 110 and more than one server 120.

The electronic device 110 is typically associated with a user (not depicted) and, as such, is sometimes referred to as a “client device”. In the illustrated implementation, the electronic device 110 is a laptop computer. The implementation of the electronic device 110 is however not limited to a laptop computer. As an example, the electronic device 110 may be implemented as a desktop computer, a laptop computer, a netbooks, a cell phone, a smartphone, a tablet and the like. The general implementation of the electronic device 110 is known in the art and, as such, will not be described here at much length.

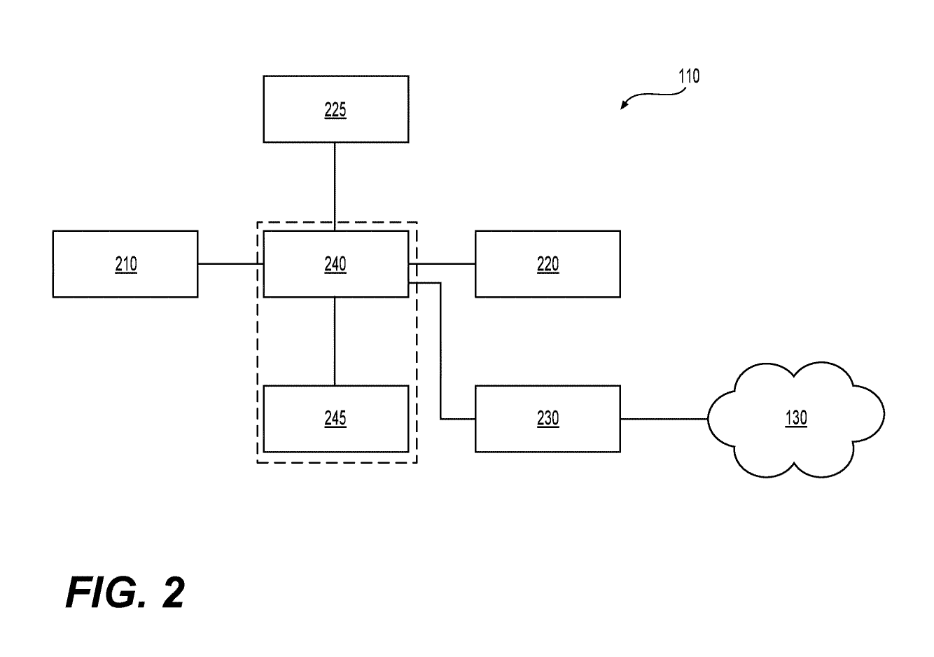

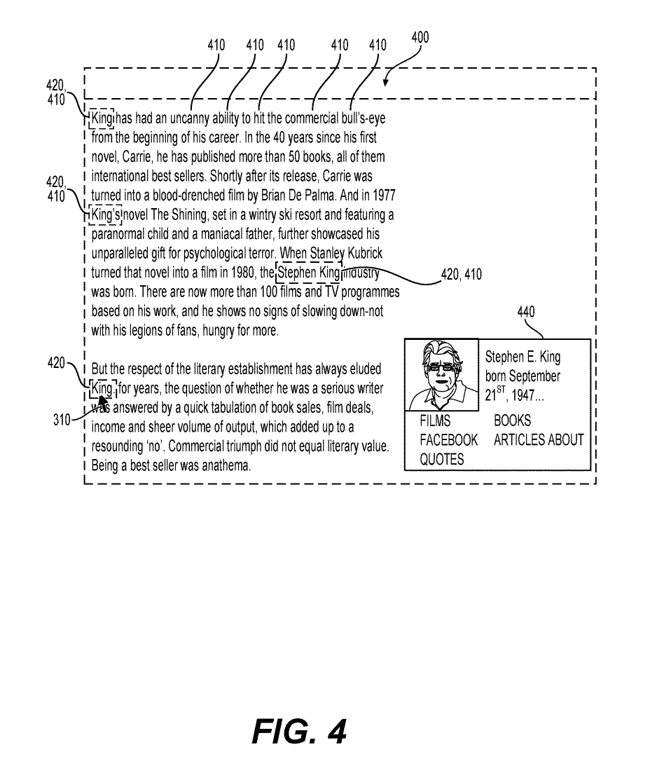

With reference to FIG. 2, the electronic device 110 includes a user input device 210 (such as a keyboard, a mouse, a touch pad, a touch screen, microphone, and the like) for receiving user inputs. The electronic device 110 includes a user output device 220 in the form of a display screen. The electronic device 110 also includes other forms of user output devices 220 such as a speaker, a printer and the like for providing other types of visual, auditory or tactile outputs to the user but these other forms of user output devices 220 will not be discussed herein. For simplicity, the user output device 220 will be referred to herein as screen 220. The electronic device 110 includes a pointing device 225 for positioning a cursor 310 (FIGS. 1 and 4) on a display screen 220. As will be readily understood by a skilled worker, the position of the cursor 310 determines the location of the subsequent user interaction. The pointing device 225 could be in the form of a mouse, a touchpad, a trackball, joystick, a finger-tracking, pen-tracking or stylus tracking element embedded in a touchscreen, and the like. In some implementations of the electronic device 110, the pointing device 225 may be integrated with the user input device 210 and/or the user output device 220, for example, in a tablet computer device, the touchscreen functions as the user input device 210, the user output device 220 as well as the pointing device 225. The electronic device 110 includes a network communication interface 230 (such as a modem, a network card and the like) for two-way communication over the communication network 130. The electronic device 110 also includes a processor 240 coupled to the user input device 210, the user output device 220, the pointing device 225 and the network communication interface 230. The processor 240 is configured to execute various methods, including those described herein below. To that end the processor 240 has a memory 245 (in the form of Random Access Memory (RAM), flash memory, or the like), or is communicatively coupled to the memory 245 that stores computer readable commands which, when executed, cause the processor 240 to execute the various methods described herein. The electronic device 110 comprises hardware and/or software and/or firmware, as is known in the art, to execute various applications, such as a browser application, a word processing application, and the like. Some of the applications on the electronic device 110 can generate documents 400 (FIGS. 1 and 4) for which contextual information can be provided by methods which will be described herein.

With reference again to FIG. 1, in the illustrated implementation of the present technology, the communication network 130 is the Internet. In other implementations of the present technology, the communication network 130 can be other than the Internet, such as a wide-area communication network, a local-area communication network, a private communication network and the like. In the communication network 130, communication occurs over various types of communication links such as wireless links (such as the Wireless Fidelity, or WiFi® for short, Bluetooth® or the like) or wired links (such as a Universal Serial Bus or USB-based connection or Ethernet based connection, for example).

Also coupled to the communication network 130 is the server 120. The server 120 is connected to the electronic device 110 via the communication network 130. The server 120 is sometimes referred to herein as “remote server” 120 as it is disposed separated from the electronic device 110 and connected thereto via the communication network 130. The server 120 could be connected a plurality of electronic devices 110. The server 120 could also be connected to other servers 120, such as but not limited to network resource servers, application servers, network configuration servers, via the communication network 130.

The server 120 can be implemented as a conventional computer server. In an example of an implementation of the present technology, the server 120 can be implemented as a Dell™ PowerEdge™ Server running the Microsoft™ Windows Server™ operating system. The server 120 could also be implemented as other kinds of network equipment such as, but not limited to, a router, a switch, or a gateway, a base station and the like. The server 120 can be implemented in any suitable hardware and/or software and/or firmware, or a combination thereof. In the depicted non-limiting implementation of present technology, the server 120 is a single server. In alternative non-limiting implementations of the present technology, the functionality of the server 120 may be distributed and may be implemented via multiple servers. The implementation of the server 120 is well known. However, briefly speaking, the server 120 comprises a network communication interface similar to the network communication interface 230 of the electronic device 110 structured and configured to communicate with the electronic device 110 and other devices coupled to the communication network 130. The server 120 further comprises at least one computer processor similar to the processor 240 of the electronic device 110 operationally connected with a memory similar to the memory 245 of the electronic device 110 and the network communication interface 230. The processor 240 of the server 120 is structured and configured to execute various methods to be described herein.

In the illustrated implementation, the server 120 is configured to analyze a body of text, such as in an email or web page, and to identify significant objects 420 (FIG. 4) therein in accordance with implementations of the present technology as will be described below in further detail. The server 120 is further configured to obtain contextually relevant information related to one or more of the significant objects 420 in the body of text.

In the illustrated implementation, the server 120 is configured as a search engine to (i) conduct searches; (ii) execute analysis of search results and perform ranking of search results; (iii) group search results and compile the search engine result page (SERP) to be output to the electronic device 110. The server 120 is communicatively coupled (or otherwise has access) to a search cluster 122. According to some implementations of the present technology, the search cluster 122 performs web searches (e.g., general and/or vertical searches) in response to a search query related to the significant objects 420 mentioned above and outputs search results for presentation to the user in a search engine results page (SERP). Within these non-limiting implementations of the present technology, the search cluster 122 comprises or otherwise has access to database(s) 124. As is known to those of skill in the art, the database 124 stores information associated with a plurality of resources potentially accessible via the communication network (for example, those resources available on the Internet). The process of populating and maintaining the database(s) 124 is generally known as “crawling”. It should be expressly understood that in order to simplify the description presented herein below, the configuration of the search cluster 122 has been greatly simplified. It is believed that those skilled in the art will be able to appreciate implementational details for the search cluster 122 and for components thereof

In some implementations of the present technology, the server 120 is communicatively coupled to another server or servers that are particularly configured as a search engine for conducting searches.

Method

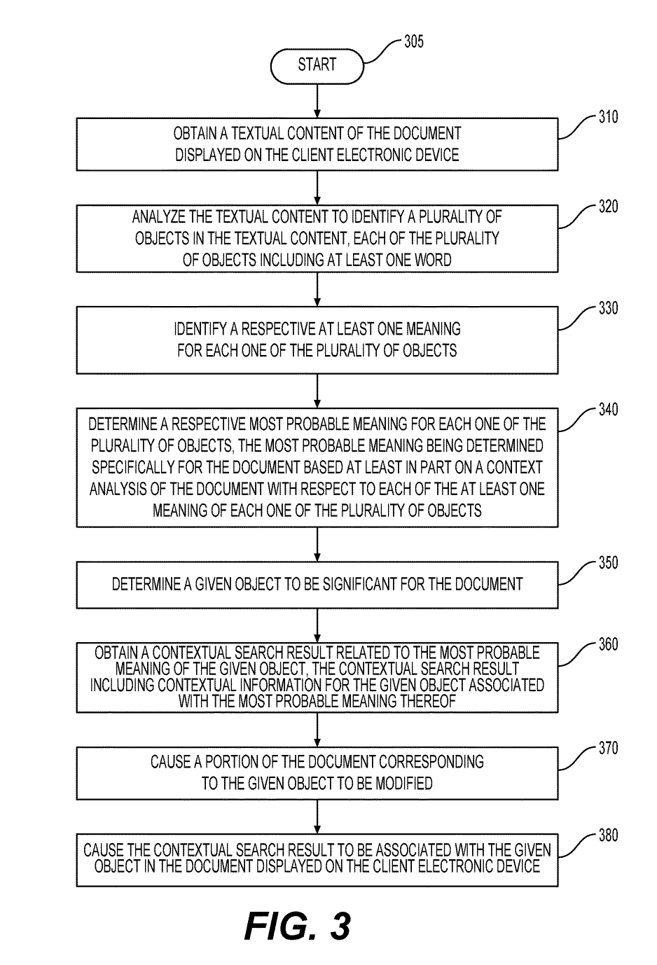

A method 300 of providing contextual information related to a body of text displayed on the screen 220 of the electronic device 110 will now be described with reference to FIGS. 3 to 5.

The method 300 is described herein using an example document 400, a portion of the document 400 being shown in FIG. 4. In the illustrated implementation, the document 400 is a web page displayed in a browser window of a browser application executed on the electronic device 110. Although the method 300 will be described with respect to textual content in the web page, it should be understood that the method 300 could be implemented for providing contextual information related to a body of text in other kinds of documents 400 such as email messages, a document created by a word processing application, and the like.

In the non-limiting implementation of the method 300 described herein, the method 300 is implemented by the processor 240 of the server 120. The server 120 could be the host server for the browser application on the client electronic device 110 or in the case of a document formed by an email message, the server 120 could be the host for the webmail application used by a receiver of the email message 400 to receive the email message.

It is further contemplated, that in some implementations, the method 300 could also be implemented, at least in part, by the processor 240 of the electronic device 110 where the document 400 is displayed. The instructions for executing the method 300, or steps thereof, could be provided as an add-on or extension of the browser application of the electronic device 110, the search application of the electronic device 110, or any other application thereof. The instructions for executing the method 300, or steps thereof, could also be stored on the electronic device 110 as a stand-alone application.

The method 300 starts at step 305 when the document 400 is “opened”, i.e. first displayed on the screen 220.

At step 310, the textual content of the document 400 is obtained. In some implementations, the server 120 receives the document 400 and extracts the textual content therefrom. In some implementations, the server 120 receives the extracted textual content.

In the illustrated implementation, where the document 400 is a web page, the server 120 receives the source code (in this example, the HTML code) of the web page and extracts the textual content from the HTML code, for example, from the DOM tree created from the HTML code for the web page. The HTML code of the web page is sent to the server 120 by the electronic device 110 as soon as the browser application on the electronic device 110 begins to execute the HTML code for displaying the web page on the screen 220. The browser application continues to execute the HTML code for displaying the web page while and after the HTML code is sent to the server 120 for execution of the method 300. In some implementations, the server 120 receives an indication of the web page being viewed on the electronic device 110, and obtains the source code from another server, for example, the host server for the web page.

At step 320, the textual content of the document 400 is analyzed to identify objects 410.

The textual content is parsed to distinguish words, and the relationships therebetween. Each word is typically identified as a distinct object 410. In some implementations, a group of words (phrase) may be identified as a single object 410, for example, if the group of words are known to be commonly found together as a phrase as in “bull's-eye”, “Stephen King”, and the like. Thus, each object 410 identified at step 320 comprises one or more words. In FIG. 4, only the objects identified in the first line have been labeled with the reference number “410” in order to avoid overcrowding of the Figure.

In order to identify objects 410 in the textual content, the server 120 has access to an object database which stores a set of objects. In the illustrated implementation of the server 120 shown in FIG. 1, the object database could be one of the databases 124, a part thereof, or multiple databases 124. In the object database, each object 410 is also associated with a set of features. Examples of features include, but are not limited to, a description of the object, an image for the object, an object type, synonyms, alternate names for the object, alternate spellings for the object, geographical location associated with object, date of birth, height and other such physical characteristics, and the like. At step 320 of the method 300, each word of the textual content is compared against the set of objects 410 in the object database to identify objects 410 in the textual content of the document 400.

In some implementations, some words of the textual content are not identified as objects. For example, words such as “is”, “then”, “today”, “then” and the like, could be disregarded and not identified as objects 410 based on factors such as frequency of occurrence, grammatical type, position of occurrence and the like. In some implementations, the processor 240 could be provided a predefined list of words to be disregarded and not identified as objects. Each word of the textual content could be compared to the predefined list of words so as to identify as objects, only those words of the textual content that do not appear on the predefined list.

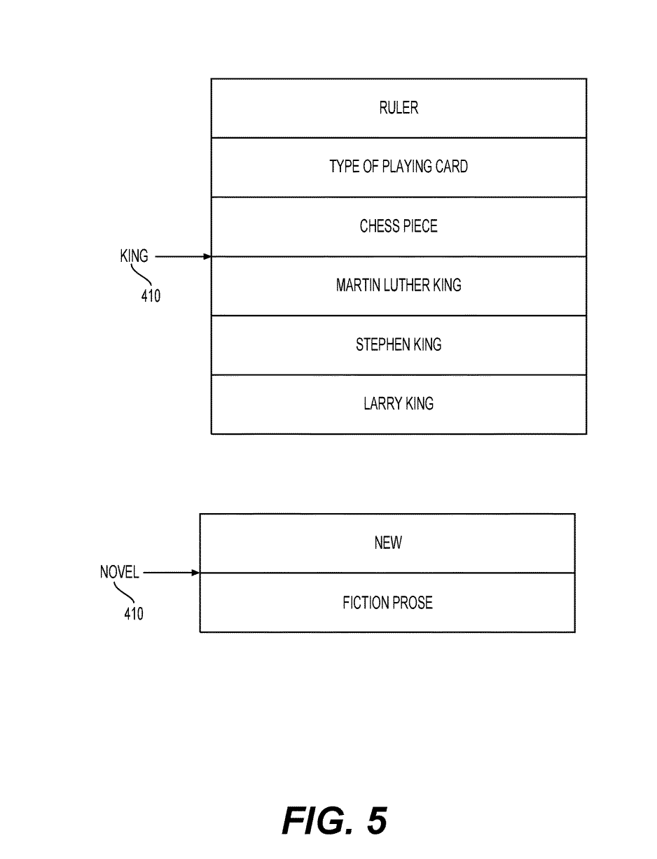

At step 330, at least one possible meaning is identified for each object 410 identified at step 320. As will be appreciated, most words have multiple meanings. For example, the word “filter” could refer to a filter in a coffeemaker, a filter for electromagnetic signals in an electronic device, and a verb signifying the act of passing through something. Thus, at step 330, each object 410 is associated with a set of possible meanings. In the illustrated implementation, as can be seen in FIG. 5, the object 410 “King” is associated with a set of possible meanings “ruler”, “type of playing card”, “chess piece”, “Stephen King”, “Martin Luther King”, and “Larry King”. In the illustrated implementation, the object database also stores a set of possible meanings associated with each object 410 in the set of objects 410 stored in the object database.

At step 340, a most probable meaning is determined for each object 410 from the set of possible meanings associated with that object. For each object, a probability score is evaluated for each of the possible meanings associated with the object. Thus, in the illustration of FIG. 4, for the object 410 “king”, a probability score is evaluated for each of the possible meanings “ruler”, “type of playing card”, “chess piece”, “Stephen King”, “Martin Luther King”, and “Larry King”.

The probability score for each possible meaning is evaluated specifically for the document 400 based on a context analysis of the document with respect to the possible meaning. The context analysis takes into account several factors such as a presence of other words and phrases in the textual content that are related to the particular possible meaning being evaluated, distance between the object 410 in question and other related words and phrases in the textual content, and the like. For example, in some implementations, each possible meaning for a particular object 410 is associated with a list of related words and phrases, and other objects 410 of the textual content (i.e. other than the particular object 410 being subjected to context analysis) may be compared to the list of related words and phrases to determine the occurrence of the related words and phrases. The probability score for a particular possible meaning of the particular object 410 is based on the occurrence of related words and phrases in the textual content. The most probable meaning for the particular object 410 could be the one that has the highest occurrence of related words and phrases in the textual content (outside the particular object). As an example, the possible meaning “Martin Luther King” could be associated with a set of related words including “slavery”, “civil rights”, “black”, “American”, “I have a dream” and the like. The presence in the textual content of an words and phrases such as “black” and “I have a dream” would increase the probability score of the possible meaning “Martin Luther King”.

The probability score for each identified possible meaning for an object 410 could also be based on an object 410 type, such as person, place, and the like. For example, if a grammatical or semantic analysis of the textual content is indicative of the object 410 being a person name, in evaluation of the probability score, a possible meaning related to a person would be given a greater weight than a possible meaning related to a thing.

The probability score for each possible meaning may also depend on the popularity of the particular possible meaning, for example, “Larry King”, as determined from statistics about the number of web searches related to the possible meaning, the number of web pages related to the possible meaning, and the like.

In general, the probability score for a possible meaning is based on a complex analysis taking into account several factors such as those discussed above. In the illustrated implementation, the probability score is evaluated by a context analysis algorithm which is based on machine learning. The context analysis algorithm has been trained using a large set of documents which have been assessed for a number of different factors such as those discussed above.

Thus, at step 340, for each object, a probability score is evaluated for each possible meaning associated with that object. For each object, the possible meaning having the highest probability score is determined to be the most probable meaning for that object.

At step 350, the textual content is analyzed to determine if a given object 410 is significant or insignificant for the document 400. An object 410 is considered to be significant if it is considered to be of interest to a user viewing the document 400, and for which the user may desire additional information. A given object 410 is determined to be significant or not significant based on the respective most probable meaning evaluated at step 340 for each object.

Thus, at step 350, one or more of the objects 410 identified at step 320 are determined to be significant for the document based on the most probable meaning evaluated at step 340 for each object.

In some implementations, each object 410 identified at step 320 is analyzed to determine whether it is significant or insignificant.

In some implementations, some of the objects 410 of the textual content are designated as being insignificant without performing the analysis described below. For example, some objects 410 having a most probable meaning related to topics considered trivial, general or common (for example, cold, vitamins, car, Russia, Twitter, and the like) could be predefined as insignificant based on the assumption that these objects 410 would not be of interest to a user, or generally known to the user, and the user would not be likely to seek additional information related to these objects. As another example, an object 410 would be designated as insignificant (for the purpose of providing to the user additional contextual information) if the textual content relates to a definition of the object. Thus, for a textual content that is related to providing a definition or description of a bumblebee, the object 410 “bumblebee” would be designated as insignificant since the user would not likely need additional information related to the object 410 “bumblebee” while viewing an article describing the bumblebee in detail.

For each of the remaining objects, i.e. the objects 410 that are not predefined to be insignificant, a context relevancy score is evaluated at step 350 to determine whether the object 410 is significant or insignificant for the document 400. In general, the context relevancy score is defined such that objects 410 having a higher context relevancy score are considered to be more significant than objects 410 having a lower context relevancy score.

The context relevancy score for each object 410 is based on the most probable meaning of that object. The context relevancy score for an object 410 for the most probable meaning thereof is evaluated based on the other objects 410 being associated with their respective most probable meaning as determined at step 340.

In the illustrated implementation, the context relevancy score is evaluated using a context relevancy algorithm which is a machine learning algorithm. The context relevancy algorithm take as input the textual content of the document 400, the most probable meaning identified at step 320 for each object, and the objects 410 of the textual content for which a context relevancy score is desired. The context relevancy algorithm is trained to provide as output a context relevancy score for each object 410 for which a context relevancy score is desired by taking into account several factors, some of which are described below. In the case where some of the objects 410 are predefined as insignificant, a context relevancy score is not evaluated for the objects 410 that are predefined as insignificant.

In general, the evaluation of the context relevancy score for a given object 410 takes into account some additional factors in addition to the factors taken into account for the evaluation of the most probable meaning for each object 410 (step 340)

In some implementations, the context relevancy score for a given object 410 for the most probable meaning thereof depends on the frequency of occurrence of the given object 410 in the textual content. As is known, in evaluating statistical quantities based the frequency of occurrence of a word, the frequency of occurrence of a particular word in a particular textual content is often weighed relative to the global frequency of occurrence of the particular word in order to account for the fact that, some words (for example, “the”) simply appear more frequently as a natural feature of a particular language. Thus, in some implementations, a first word that is not otherwise a frequently occurring word would be considered to be a significant object 420 if it occurs frequently in the textual content of the document 400, and the first word would therefore have a higher context relevancy score than a second word that occurs less frequently in the document 400 relative to the frequency of occurrence of the second word in a global sense.

In some implementations, the context relevancy score for a given object 410 for the most probable meaning thereof also depends on the frequency of occurrence of other objects 410 having a respective most probable meaning that is related to the most probable meaning of the given object. Hence, for example, the contextual relevancy score of the most probable meaning “Stephen King” of a first object 410 “King” would be higher if the textual content contained other objects 410 such as “Carrie” and “Clockwork Orange” that have a respective most probable meaning that is related to the most probable meaning “Stephen King” of the given object 410 “King”.

In some implementations, the context relevancy score for each object 410 for the most probable meaning thereof depends on the popularity of the most probable meaning of that object, for example, “Stephen King”, as determined from statistics about the number of web searches related to the most probable meaning, the number of web pages related to the most probable meaning, and the like. The popularity of an object 410 could be defined using any other suitable metric.

In some implementations, an object 410 is considered to be significant or insignificant based on the position of the object 410 in the textual content. For example, the context relevance score for a given object 410 could be based on a position of the object 410 relative to the beginning of the textual content. As another example, an object 410 near the end of a textual content could be considered to be more significant than an object 410 in the middle of a textual content.

The context relevancy score for each object 410 for the most probable meaning thereof could also be based on an object 410 type, such as person, place, and the like.

As mentioned above, in general, objects 410 having a higher context relevancy score are considered to be more significant than objects 410 having a lower context relevancy score.

In some implementations, a context relevancy score threshold is predefined, and any object 410 having a context relevancy score greater than the context relevancy score threshold is determined to be significant.

In some implementations, the objects 410 are ranked based on their context relevancy scores, and one or more of the objects 410 are then determined to be significant based on the context relevancy score.

In some other implementations, the number of significant objects 420 is predefined. An object 410 is determined to be significant or insignificant based on the ranking based on the context relevancy score. For example, if the number of significant objects 420 is predefined to be three, the objects 410 having the highest, second-highest and third-highest context relevancy score are determined to be significant while all other objects 410 having a context relevancy score less than the third-highest context relevancy score are determined to be insignificant. In some implementations, the number of significant objects 420 is predefined to be one, and only the object 410 having the highest context relevancy score is determined to be significant while all the other objects 410 are determined to be insignificant.

In the illustrated implementation, the number of significant objects 420 is predefined to be one, and for the illustrated document 400 of FIG. 4, the object 410 “King” is determined to be significant. As can be seen in FIG. 4, the object 410 “King” occurs multiple times in the textual content, each occurrence of the object 410 “King” being associated with the most probable meaning “Stephen King”.

After identification of significant objects 420 at step 350, steps 360 to 380 are executed with respect to each of the objects 410 determined to be significant.

At step 360, a contextual search result is obtained for each significant object. The contextual search result is obtained by performing a search using as a search query (contextual search query), the most probable meaning of the significant object. Thus, in the illustrated implementation of FIG. 5, the contextual search query for the significant object 420 “King” is “Stephen King”. Although the contextual search result is referred to herein in the singular, it should be understood that a search performed using as a search query, the most probable meaning of a significant object 420 could and generally does provide multiple search results. Thus, the term “contextual search result” is intended to encompass a single search result as well as multiple search results.

In the illustrated implementation, the server 120 is a search engine server, and therefore the contextual search is performed by the server 120 itself, in conjunction with the search cluster 122 and the databases 124, to obtain the contextual search results. In some other implementations, the server 120 sends the search query to a communicatively coupled search engine server and receives the contextual search result from the communicatively coupled search engine server.

At step 370, a portion of the document 400 corresponding to the significant object 420 is modified. In the illustrated implementation, for each object 410 that is determined to be significant (significant object), the server 120 sends to the electronic device 110, an indication of the significant object. The indication of the significant object 420 could include the one or more words of the significant object 420 along with a position or location of the significant object 420 in the textual content. As a result of the electronic device 110 receiving, from the server 120, the indication of the significant object 420 at step 370, a portion of the document 400 corresponding to the significant object 420 is modified.

In the illustrated implementation, the indication of the significant object 420 is sent in the form of a vector which includes an identification of the significant object 420 (for example, object #2305) and the word(s) included in the significant object 420 (for example, “King”). If there are multiple significant objects, the indication of the significant object 420 could be sent as a table of vectors, each vector including an object identification number and the one or more words of the corresponding significant object 420.

The portion of the document 400 corresponding to the significant object 420 is modified to be indicative of the object 410 being significant. For example, the one or more words comprising the significant object 420 could be highlighted, underlined, circled, or otherwise distinguished on the screen 220. For example, the one or more words comprising the significant object 420 could be depicted on the screen 220 in a different colour or font. It is contemplated that a tag (for example, in the shape of an upward arrow) could be placed in the document 400 adjacent the one or more words comprised in the significant object. Other ways of modifying an object 410 in order to be indicative of the significant object 420 are also contemplated.

In the illustrated implementation, as can be seen in FIG. 4, the object 410 “King” is highlighted. In the illustrated implementation, each occurrence of the object 410 “King” is highlighted. In some implementations, only one occurrence of the object 410 “King” is highlighted. For example, only the first occurrence of the object 410 “King” could be highlighted.

At step 380, the contextual search result obtained for the significant object 420 for the most probable meaning thereof is associated with the significant object 420 in the textual content. Associating the contextual search result with the significant object 420 refers to displaying the contextual search result in association with the significant object. In some implementations, the contextual search results related to a given object 410 are displayed in proximity to the given object 410 in the document 400. In some implementations, the contextual search results related to a given object 410 are displayed when the user viewing the document interacts with the given object 410 in the document 400.

With reference to FIG. 4, in the illustrated implementation, the significant object 420 “King” is modified to be highlighted and user selectable. When a user hovers the cursor 310 over the object 410 “King”, the contextual search result related to “Stephen King” is displayed overlaid over the document 400. The user may then be presented with an option of having the contextual search results opened in a new browser application window. The option for having the contextual search results opened in a new window can be selected in this implementation by right-clicking with the mouse 225.

In some implementations, the significant object 420 may be modified such that a user has to select the significant object 420 (by clicking on the object 410 with the mouse 225) in order to have the contextual search result displayed overlaid on the document 400. It is contemplated that a tag (for example in the shape of an upward arrow) could be placed in the document 400 adjacent the one or more words comprised in the significant object. In this case, the tag could be configured to be user-selectable such that clicking on the tag would cause a display of the contextual search results related to the object.

Thus, in both examples above, the significant object 420 is modified to be user selectable to cause the display of the contextual search results when selected. As will be understood, the significant object 420 is modified to be user selectable by modifying the source code for rendering the document 400 on the screen 220 of the electronic device 110.

In some implementations, the contextual search result for an object 410 is sent to the electronic device 110 together with the indication of the significant object 420 (step 360). In some implementations, the contextual search result is sent to the to the electronic device 110 separately from the indication of the significant object.

In some implementations, the contextual information for the significant object 420 is obtained as a result of the user of the electronic device 110 interacting with the significant object 420 thereby indicating an interest in the significant object. Thus, in such implementations, the contextual search is performed (step 360) and the contextual search result is sent to the electronic device 110 after the indication of the significant object 420 is sent to the electronic device 110 (step 370) and as a result of the user of the electronic device 110 interacting with the significant object 420 in the document 400.

### Presentation of Contextual Information

The contextual search result for the significant object 420 for the most probable meaning thereof is presented to the user on the screen 220 of the electronic device 110. In some implementations, the contextual search result is presented in the form of a SERP. With reference to FIG. 4, in some implementations, the server 120 processes the contextual search result to compile the information from the contextual search result into an object reference card 440. As can be seen in FIG. 4, in the illustrated implementation, the object reference card 440 for the object 410 “King” is compiled from the contextual search results obtained for its most probable meaning “Stephen King”. The obtained search results for “Stephen King” are organized under different user-selectable headings “Films”, “Books”, “Articles About” and the like. The user can select one of these categories to view the contextual search results related to that particular category. The contextual search results are compiled to form the object reference card 440 using known summarization and grouping algorithms which will not be discussed herein in any more detail.

The object reference card 440 could be compiled so as to present the contextual information in a predefined format, to include and/or exclude certain types of contextual information, to highlight certain types of information, and such. For example, the object reference card 440 could be formatted according to the type of significant object for which the object reference card 440 is compiled. As an example, the object reference card for a place name could have an image of a map while an object reference card for a person, animal or an inanimate entity (thing) could have an image thereof. As another example, each type of electronic device 110 could be associated with a particular format of the object reference card 440. Thus, the object reference card 440 for display on a laptop computer could be different from the object reference card 440 for display on a smartphone.

In the illustrated implementation, the contextual information for a significant object 420 is sent in the form of a table including an identification of the significant object 420 (for example, object #2305), the unformatted and uncompiled contextual search result, and an object reference card 440 including the contextual search result compiled and formatted for the electronic device 110. In some implementations, the table includes a template for object reference card 440 without actually including the object reference card 440 having compiled and formatted contextual search results. The identification of the significant object 420 is used by the electronic device 110 to match the contextual search result to corresponding significant object 420 in the previously received table of significant object(s) 420 (step 370). It is contemplated that the table with the contextual search result could be combined with the table of significant objects 420 (sent at step 370) so that the indication of the significant object 420 and the corresponding contextual information is sent to the electronic device 110 at the same time.

The method 300 described herein is not limited to any particular format for presenting the contextual information.

The present technology as described herein allows highly relevant contextual information to be automatically presented to the user while requiring few actions by the user. For example, the user does not request any searches, and may not even have to interact with the document 400 being viewed in order to obtain supplemental information relevant to the text being viewed. The relevant information provided to the user is obtained more efficiently since the searches are performed only for the objects 410 determined to be significant for the document 400, and only related to the most probable meaning of the words corresponding to the object 410 determined to be significant. Thus, the present technology affords an overall improvement in user experience without significant increase in the consumption of resources such as bandwidth and energy. The present technology can be implemented in devices having lower processing and energy storage capabilities than some of the other presently known web search technologies, thus enabling electronic devices implementing the present technology to be smaller in physical size.

It should be expressly understood that not all technical effects mentioned herein need to be enjoyed in each and every implementation of the present technology. For example, implementations of the present technology may be implemented without the user enjoying some of these technical effects, while other implementations may be implemented with the user enjoying other technical effects or none at all.

Clause 1. A method (300) of providing contextual information related to a document (400) displayed on a client electronic device (110), the method being executed by a processor (240), the method (300) comprising:

obtaining a textual content of the document (400) displayed on the client electronic device (110);
analyzing the textual content to identify a plurality of objects (410) in the textual content, each of the plurality of objects (410) including at least one word;
for each one of the plurality of objects (410):
identifying a respective at least one meaning for each one of the plurality of objects (410); and
determining a respective most probable meaning for each one of the plurality of objects (410), the most probable meaning being determined specifically for the document (400) based at least in part on a context analysis of the document (400) with respect to each of the at least one meaning of each one of the plurality of objects (410); and
for a given object (410) of the plurality of objects (410):
determining if the given object (410) is significant for the document (400);
responsive to determining that the given object (410) is significant, for the given object (410):
obtaining a contextual search result related to the most probable meaning of the given object (410), the contextual search result including contextual information for the given object (410) associated with the most probable meaning thereof;
causing a portion of the document (400) corresponding to the given object (410) to be modified; and
causing the contextual search result to be associated with the given object (410) in the document (400) displayed on the client electronic device (110).

Clause 2. The method (300) of clause 1, wherein the determining if the given object (410) is significant for the document (400) comprises:

comparing a contextual relevance of the most probable meaning of the given object (410) to a contextual relevance threshold; and
responsive to the contextual relevance of the most probable meaning of the given object (410) being greater than the contextual relevance threshold, determining that the given object (410) is significant.

Clause 3. The method (300) of clause 1, wherein the determining if the given object (410) is significant for the document (400) comprises:

comparing a contextual relevance of the most probable meaning of the given object (410) to a respective contextual relevance of the respective most probable meaning of each one of the plurality of objects (410) other than the given object (410); and
determining the given object (410) is significant for the document (400) responsive to the contextual relevance of the most probable meaning of the given object (410) being greater than the respective contextual relevance of the most probable meaning of each one of the plurality of objects (410) other than the given object (410).

Clause 4. The method (300) of any one of clauses 1 to 3 wherein the determining if the given object (410) is significant for the document (400) is based at least in part on at least one of the following:

a frequency of occurrence in the document (400) of the at least one word comprised in the given object (410);
a popularity of the at least one word comprised in the given object (410);
a position of the given object (410); and
an object (410) type of the given object (410).

Clause 5. The method (300) of clause 1, wherein:

the given object (410) is a first object (410); and
the contextual search result is a first object (410) contextual search result, the method (300) further comprising:
determining if a second object (410) of the plurality of objects (410) is significant for the document (400); and
responsive to determining that the second object (410) is significant:
obtaining a second object (410) contextual search result related to the most probable meaning of the second object, the second object (410) contextual search result including contextual information for the second object (410) associated with the most probable meaning thereof;
causing a portion of the document (400) corresponding to the second object (410) to be modified; and
causing the second object (410) contextual search result to be associated with the second object (410) in the document (400) displayed on the client electronic device (110).

Clause 6. The method (300) of clause 5, wherein:

the determining if the first object (410) is significant for the document (400) comprises:
comparing a contextual relevance of the most probable meaning of the first object (410) to a contextual relevance threshold; and
determining the first object (410) to be significant responsive to the contextual relevance of the most probable meaning of the first object (410) being greater than the contextual relevance threshold; and
determining if the second object (410) is significant for the document (400) comprises:
comparing a contextual relevance of the most probable meaning of the second object (410) to the contextual relevance threshold; and
determining the second object (410) to be significant responsive to the contextual relevance of the most probable meaning of the second object (410) being greater than the contextual relevance threshold.

Clause 7. The method (300) of clause 5, wherein:

the determining if the first object (410) is significant for the document (400) comprises:
comparing a contextual relevance of the most probable meaning of the first object (410) to a respective contextual relevance of the respective most probable meaning of each one of the plurality of objects (410) other than the first object (410); and
determining the first object (410) is significant for the document (400) responsive to the contextual relevance of the most probable meaning of the first object (410) being greater than the respective contextual relevance of the most probable meaning of each one of the plurality of objects (410) other than the first object (410); and
the determining if the second object (410) is significant for the document (400) comprises:
comparing the contextual relevance of the most probable meaning of the second object (410) to the respective contextual relevance of the respective most probable meaning of each one of the plurality of objects (410) other than the second object (410); and
determining the second object (410) is significant for the document (400) responsive to the contextual relevance of the most probable meaning of the second object (410) being greater than the respective contextual relevance of the most probable meaning of each one of the plurality of objects (410) except the second object (410) and the first object (410).

Clause 8. The method (300) of any one of clauses 1 to 5, wherein obtaining the contextual search result related to the most probable meaning of the given object (410) comprises:

performing a contextual search using the most probable meaning of the given object (410) as a contextual search query to obtain the contextual search result.

Clause 9. The method (300) of clause 8, wherein performing the contextual search comprises:

performing the contextual search responsive to the user interacting with the given object (410) in the document (400) displayed on the client electronic device (110).

Clause 10. The method (300) of any one of clauses 1 to 5, 8 and 9, wherein causing a portion of the document (400) corresponding to the given object (410) to be modified comprises:

causing the at least one word corresponding to the given object (410) to be user-selectable such that a user selection of the at least one word corresponding to the given object (410) causes presentation of the contextual search result obtained for the most probable meaning for the given object (410).

Clause 11. The method (300) of any one of clauses 1 to 5 and 8 to 10, wherein causing the contextual search result to be associated with the given object (410) in the document (400) displayed on the client electronic device (110) comprises:

causing displaying of the contextual search result in proximity to the at least one word in the document (400) corresponding to the given object (410).

Clause 12. The method (300) of clause 11, further comprising preparing a object reference card (440) based on the contextual search result, wherein:

causing displaying of the contextual search result comprises causing displaying of the object reference card (440).

Clause 13. The method (300) of any one of clauses 1 to 12, wherein:

the method is executed at a server (120) comprising the processor (240), the server (120) being communicatively coupled to the client electronic device (110); and wherein
obtaining the textual content of the document (400) displayed on the client electronic device (110) comprises receiving, from the client electronic device (110), an indication of the document (400);
causing a portion of the document (400) corresponding to the given object (410) to be modified comprises transmitting to the client electronic device (110) an indication of the given object (410); and
causing the contextual search result to be associated with the given object (410) in the document (400) displayed on the client electronic device (110) comprises transmitting to the client electronic device (110) the contextual search result.

Clause 14. The method (300) of any one of clauses 1 to 12, wherein the method is executed at the client electronic device (110),

wherein obtaining the contextual search result related to the most probable meaning of the given object (410) comprises:
sending to a search engine server (120) the most probable meaning of the given object (410) as a contextual search query; and
receiving from the search engine server (120) the contextual search result including contextual information for the given object (410) for the most probably meaning thereof.

Clause 15. An electronic device (110) for providing contextual information related to a document (400), the electronic device (110) comprising:

a processor (240);
a user output device (110) communicatively coupled to the processor (240) for displaying the document (400); and
a network communication interface communicatively coupled to the processor (240) for communicating with a search engine server (120),
the processor (240) being configured to execute the method (300) of any one of clauses 1 to 12,
wherein obtaining the contextual search result related to the most probable meaning of the given object (410) comprises:
sending to the search engine server (120) the most probable meaning of the given object (410) as a contextual search query; and
receiving from the search engine server (120) the contextual search result including contextual information for the given object (410) for the most probably meaning thereof.

Clause 16. A server (120) for providing contextual information related to a document (400) displayed on a client electronic device (110), the server (120) comprising:

a processor (240); and
a network communication interface communicatively coupled to the processor (240) for communicating with client electronic device (110),
the processor (240) being configured to execute the method (300) of any one of clauses 1 to 12,
wherein:
obtaining the textual content of the document (400) displayed on the client electronic device (110) comprises receiving, from the client electronic device (110), an indication of the document (400);
causing a portion of the document (400) corresponding to the given object (410) to be modified comprises transmitting to the client electronic device (110) an indication of the given object (410); and
causing the contextual search result to be associated with the given object (410) in the document (400) displayed on the client electronic device (110) comprises transmitting to the client electronic device (110) the contextual search result.

Clause 17. The server (120) of clause 16, wherein obtaining the contextual search result related to the most probable meaning of the given object (410) comprises:

performing a contextual search using the most probable meaning of the given object (410) as a contextual search query to obtain the contextual search result.

One skilled in the art will appreciate when the instant description refers to “receiving data” from a user that the electronic device 110 executing receiving of the data from the user may receive an electronic (or other) signal from the user. One skilled in the art will further appreciate that displaying data to the user via a user-graphical interface (such as the screen 220 of the electronic device 110 and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method of providing contextual information related to a document displayed on a client electronic device, the method being executed by a processor, the method comprising:
obtaining a textual content of the document displayed on the client electronic device;
analyzing the textual content to identify a plurality of objects in the textual content, each of the plurality of objects including at least one word;
for each one of the plurality of objects:
identifying a respective at least one meaning for each one of the plurality of objects; and
determining a respective most probable meaning for each one of the plurality of objects, the most probable meaning being determined specifically for the document based at least in part on a context analysis of the document with respect to each of the at least one meaning of each one of the plurality of objects; and
for a given object of the plurality of objects:
determining if the given object is significant for the document;
responsive to determining that the given object is significant, for the given object:
obtaining a contextual search result related to the most probable meaning of the given object, the contextual search result including contextual information for the given object associated with the most probable meaning thereof;
causing a portion of the document corresponding to the given object to be modified; and
causing the contextual search result to be associated with the given object in the document displayed on the client electronic device.

2. The method of claim 1, wherein the determining if the given object is significant for the document comprises:
comparing a contextual relevance of the most probable meaning of the given object to a contextual relevance threshold; and
responsive to the contextual relevance of the most probable meaning of the given object being greater than the contextual relevance threshold, determining that the given object is significant.

3. The method of claim 1, wherein the determining if the given object is significant for the document comprises:
comparing a contextual relevance of the most probable meaning of the given object to a respective contextual relevance of the respective most probable meaning of each one of the plurality of objects other than the given object; and
determining the given object is significant for the document responsive to the contextual relevance of the most probable meaning of the given object being greater than the respective contextual relevance of the most probable meaning of each one of the plurality of objects other than the given object.

4. The method of claim 1, wherein the determining if the given object is significant for the document is based at least in part on at least one of the following:
a frequency of occurrence in the document of the at least one word comprised in the given object;
a popularity of the at least one word comprised in the given object;
a position of the given object; and
an object type of the given object.

5. The method of claim 1, wherein:
the given object is a first object; and
the contextual search result is a first object contextual search result,
the method further comprising:
determining if a second object of the plurality of objects is significant for the document; and
responsive to determining that the second object is significant:
obtaining a second object contextual search result related to the most probable meaning of the second object, the second object contextual search result including contextual information for the second object associated with the most probable meaning thereof;
causing a portion of the document corresponding to the second object to be modified; and
causing the second object contextual search result to be associated with the second object in the document displayed on the client electronic device.

6. The method of claim 5, wherein:
the determining if the first object is significant for the document comprises:
comparing a contextual relevance of the most probable meaning of the first object to a contextual relevance threshold; and
determining the first object to be significant responsive to the contextual relevance of the most probable meaning of the first object being greater than the contextual relevance threshold; and
determining if the second object is significant for the document comprises:
comparing a contextual relevance of the most probable meaning of the second object to the contextual relevance threshold; and
determining the second object to be significant responsive to the contextual relevance of the most probable meaning of the second object being greater than the contextual relevance threshold.

7. The method of claim 5, wherein:
the determining if the first object is significant for the document comprises:
comparing a contextual relevance of the most probable meaning of the first object to a respective contextual relevance of the respective most probable meaning of each one of the plurality of objects other than the first object; and
determining the first object is significant for the document responsive to the contextual relevance of the most probable meaning of the first object being greater than the respective contextual relevance of the most probable meaning of each one of the plurality of objects other than the first object; and
the determining if the second object is significant for the document comprises:
comparing the contextual relevance of the most probable meaning of the second object to the respective contextual relevance of the respective most probable meaning of each one of the plurality of objects other than the second object; and
determining the second object is significant for the document responsive to the contextual relevance of the most probable meaning of the second object being greater than the respective contextual relevance of the most probable meaning of each one of the plurality of objects except the second object and the first object.

8. The method of claim 1, wherein obtaining the contextual search result related to the most probable meaning of the given object comprises:
performing a contextual search using the most probable meaning of the given object as a contextual search query to obtain the contextual search result.

9. The method of claim 8, wherein performing the contextual search comprises:
performing the contextual search responsive to the user interacting with the given object in the document displayed on the client electronic device.

10. The method of claim 1, wherein causing a portion of the document corresponding to the given object to be modified comprises:
causing the at least one word corresponding to the given object to be user-selectable such that a user selection of the at least one word corresponding to the given object causes presentation of the contextual search result obtained for the most probable meaning for the given object.

11. The method of claim 1, wherein causing the contextual search result to be associated with the given object in the document displayed on the client electronic device comprises:
causing displaying of the contextual search result in proximity to the at least one word in the document corresponding to the given object.

12. The method of claim 11, further comprising preparing a object reference card based on the contextual search result, wherein:
causing displaying of the contextual search result comprises causing displaying of the object reference card.

13. The method of claim 1, wherein:
the method is executed at a server comprising the processor, the server being communicatively coupled to the client electronic device; and wherein
obtaining the textual content of the document displayed on the client electronic device comprises receiving, from the client electronic device, an indication of the document;
causing a portion of the document corresponding to the given object to be modified comprises transmitting to the client electronic device an indication of the given object; and
causing the contextual search result to be associated with the given object in the document displayed on the client electronic device comprises transmitting to the client electronic device the contextual search result.

14. The method of claim 1, wherein the method is executed at the client electronic device,
wherein obtaining the contextual search result related to the most probable meaning of the given object comprises:
sending to a search engine server the most probable meaning of the given object as a contextual search query; and
receiving from the search engine server the contextual search result including contextual information for the given object for the most probably meaning thereof.

15. An electronic device for providing contextual information related to a document, the electronic device comprising:
a processor;
a user output device communicatively coupled to the processor for displaying the document; and
a network communication interface communicatively coupled to the processor for communicating with a search engine server,
the processor being configured to execute the method of claim 1,
wherein obtaining the contextual search result related to the most probable meaning of the given object comprises:
sending to the search engine server the most probable meaning of the given object as a contextual search query; and
receiving from the search engine server the contextual search result including contextual information for the given object for the most probably meaning thereof.

16. A server for providing contextual information related to a document displayed on a client electronic device, the server comprising:
a processor; and
a network communication interface communicatively coupled to the processor for communicating with client electronic device,
the processor being configured to execute the method of claim 1,
wherein:
obtaining the textual content of the document displayed on the client electronic device comprises receiving, from the client electronic device, an indication of the document;
causing a portion of the document corresponding to the given object to be modified comprises transmitting to the client electronic device an indication of the given object; and
causing the contextual search result to be associated with the given object in the document displayed on the client electronic device comprises transmitting to the client electronic device the contextual search result.

17. The server of claim 16, wherein obtaining the contextual search result related to the most probable meaning of the given object comprises:
performing a contextual search using the most probable meaning of the given object as a contextual search query to obtain the contextual search result.
